(19) United States
(12) Patent Application Publication
(10) Pub. No.: US 2005/0240671 A1
(43) Pub. Date: Oct. 27, 2005

(54) IP-based front-end web server

(76) Inventors: Loraine Beyer, Birmingham, AL (US); Anita Simpson, Decatur, GA (US); Karen Mullis, Loganville, GA (US)

Correspondence Address: Scott P. Zimmerman, P.O. Box 3822, Cary, NC, 27519, US

(21) Appl. No.: 10/830,640

(22) Filed: Apr. 23, 2004

(51) Int. Cl. G06F 15/16

(52) U.S. Cl. 709/227

(57) ABSTRACT

Methods, systems, and products are disclosed for providing unified access to communications services offered by vendors. One method presents an interface to a unified communications service offered by a communications service provider. If a user is authenticated to the unified communications service, the user is presented one or more communications services offered by a vendor that the user may access.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND OF THE INVENTION

1. Field of the Invention

This invention generally relates to electrical computers and, more particularly, to multiple computer or process coordinating and support.

2. Description of the Related Art

Voice-Over Internet Protocol technology provides enhanced features and services. Voice-Over Internet Protocol (VoIP) transports voice services over data networks. Because VoIP utilizes packet switching networks, VoIP technology replaces expensive hardware with software protocols for supporting common and new telephony services, such as conferencing, events notification, and instant messaging. VoIP technology also offers end users (such as subscribers) the ability to self-select and to self-configure their desired communications services.

Although VoIP technology is promising, configuration is cumbersome. Although VoIP provides many new telephony and Internet services, these advancements are provided by multiple vendors. That is, multiple third-party vendors supply the software applications for VoIP services. When the end user wishes to configure their VoIP service, the end user must access each vendor's web-based application. The end user, for example, must access one vendor's application to configure call forwarding service, another vendor's application for email service, another vendor's application for messaging service, and so on. Each vendor generally requires a login procedure, so the end user is required to separately perform multiple login and logout procedures. These multiple login and logout procedures are prone to error and often frustrate the end user. These multiple login and logout procedures also require much time to complete, and the user has a less-than-favorable overall experience with the configuration process. There is, accordingly, a need in the art for methods, systems, and products for reducing or even eliminating these multiple login/logout procedures. There is also a need in the art for a coherent and user-friendly interface that offers simple and quick access to vendor applications.

### BRIEF SUMMARY OF THE INVENTION

The aforementioned problems, and other problems, are reduced by this invention. This invention comprises methods, computer systems, computer programs, and computer program products that provide unified access to communications services. This invention is a “front-end” web server architecture that presents a coherent and branded interface for a subscriber of multiple communications services. Heretofore if subscriber (or “end user”) wanted to configure multiple communications applications/services, the end user had to separately login and logout for each application/service. This invention, however, provides a common “front end” for these separate communications applications. Even though the end user might receive communications services from multiple service providers and/or third-party vendors, this invention presents a unified web portal for all the communications services. The end user may thus easily and quickly select and configure one or more communications services, all with a single sign-on feature. No separate login/logout process is necessary with this invention. The end user can use this invention to configure all their communications services, including email, voicemail, unified messaging, cellular service, call forwarding, internet service, and any other communications service/feature/application. This invention bundles many services, offered by many different vendors, and neatly presents these services to the end user.

This invention discloses methods, systems, and products for providing unified access to communications services. One of the embodiments describes a unified interface for accessing and for configuring one or more communications services. An interface to a unified communications service is stored in memory for presentation to a user. The unified communications service is offered by a communications service provider. If a user is authenticated to the unified communications service, the user is permitted to access one or more communications services offered by a vendor.

Other embodiments of this invention describe another method for providing unified access to communications services. Here an interface to a unified communications service is stored and communicated by a communications service provider. If a user is authenticated to the unified communications service, then the user is provided access to one or more communications services offered by a vendor. The one or more communications services may include a conferencing service. This conferencing service allows a subscriber to establish a conference session, yet the conferencing service only allows a non-subscriber to participate in the conferencing session. The one or more communications services may also include a bandwidth on-demand communications service. This bandwidth on-demand communications service allows the subscriber to receive increased bandwidth for downloading data and, when the data is downloaded, the increased bandwidth is eliminated.

Still more embodiments of this invention describe a system for providing unified access to communications services. A memory device stores a Unified Communications Module, and a processor communicates with the memory device. The Unified Communications Module stores an interface to a unified communications service offered by a communications service provider. The Unified Communications Module authenticates the user to the unified communications service and, if the user is authenticated, the Unified Communications Module then allows the user to access one or more communications services offered by a vendor. The one or more communications services include an electronic mail service, a unified messaging service, a conferencing service, and a customer administrative service. The conferencing service allows a subscriber to establish a conference session and allows a non-subscriber to only participate in the conferencing session.

Other embodiments of this invention describe a computer program product. A computer-readable medium stores a Unified Communications Module. The Unified Communications Module stores an interface to a unified communications service. If a user is authenticated to the unified communications service, then the user is provided access to one or more communications services offered by a vendor. The one or more communications services may include a conferencing service. This conferencing service allows a subscriber to establish a conference session, yet the conferencing service only allows a non-subscriber to participate in the conferencing session. The one or more communications services may also include a bandwidth on-demand communications service. This bandwidth on-demand communications service allows the subscriber to receive increased bandwidth for downloading data and, when the data is downloaded, the increased bandwidth is eliminated.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE SEVERAL VIEWS OF THE DRAWINGS

These and other features, aspects, and advantages of the embodiments of the present invention are better understood when the following Detailed Description of the Invention is read with reference to the accompanying drawings, wherein:

FIG. 1 is a schematic illustrating an operating environment for the embodiments of this invention;

FIG. 2 is a schematic illustrating an alternative architecture for a conferencing service, according to the embodiments of this invention;

FIGS. 3 and 4 are schematics illustrating additional communications services presented by a unified communications interface, according to the embodiments of this invention;

FIGS. 5 and 6 are schematics illustrating Graphical User Interfaces, according to more embodiments of this invention;

FIG. 7 illustrates an alternative operating environment for this invention, according to still more embodiments of this invention; and

FIGS. 8 and 9 are flowcharts illustrating a method for providing unified access to communications services.

### DETAILED DESCRIPTION OF THE INVENTION

This invention now will be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

This invention provides a unified access to communications services. This invention is a “front-end” web server architecture that presents a coherent and branded interface for a subscriber of multiple communications services. Heretofore if subscriber (or “end user”) wanted to configure multiple communications applications/services, the end user had to separately login and logout for each application/service. This invention, however, provides a common “front end” for these separate communications applications. Even though the end user might receive communications services from multiple service providers and/or third-party vendors, this invention presents a unified web portal for all the communications services. The end user may thus easily and quickly select and configure one or more communications services, all with a single sign-on feature. No separate login/logout process is necessary with this invention. The end user can use this invention to configure all their communications services, including email, voicemail, unified messaging, cellular service, call forwarding, internet service, and any other communications service/feature/application. This invention bundles many services, offered by many different vendors, and neatly presents these services to the end user.

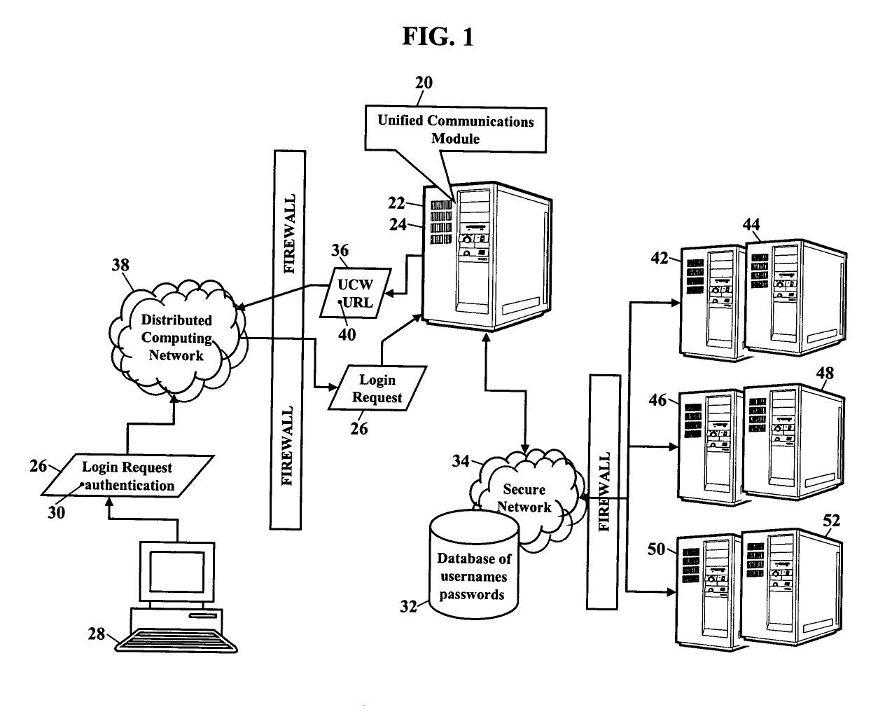

FIG. 1 is a schematic illustrating an operating environment, according to the embodiments of this invention. FIG. 1 shows a Unified Communications Module 20. The Unified Communications Module 20 comprises methods, systems, computer programs, and/or computer program products that provide unified access to communications services offered by a communications service provider and third-party vendors. The Unified Communications Module 20 is stored/maintained within any computer system 22, such as a web server 24. As the following paragraphs will explain, the Unified Communications Module 20 provides a single, integrated web portal interface with a listing of features and services available to an end user. The Unified Communications Module 20 has a “single sign-on” feature for the end user, thus presenting the end user with a single login and password for accessing communications services. The Unified Communications Module 20 thus presents the end user with an interface having a unified “look and feel,” despite one or multiple vendor platforms that provide the end user's communications services.

FIG. 1 illustrates the operating architecture for the Unified Communications Module 20. The Unified Communications Module 20 is stored/maintained within the web server 24. The Unified Communications Module 20 receives a login request 26 from an end user computer 28. The login request 26 includes authentication information 30, such as a username and password, that is unique to the end user. The Unified Communications Module 20 then requests authentication from a database 32 of valid usernames and passwords. The database 32 of valid usernames and passwords may be locally stored/maintained at the web server 24, or the database 32 of valid usernames and passwords may be remotely (and securely) accessed via a secure network 34. The Unified Communications Module 20 queries the database 32 of valid usernames and passwords. If the end user's authentication information 30 is validated, the Unified Communications Module 20 return communicates a unified communications webpage 36 (shown as “UCW”) via a distributed computing network 38. The distributed computing network 38 may include the Internet (sometimes alternatively known as the “World Wide Web”), an intranet, a local-area network (LAN), and/or a wide-area network (WAN). When the end user computer 28 receives the unified communications webpage 36, the end user computer 28 audibly and/or visually presents the unified communications webpage 36 to the end user.

Because the end user is authenticated, the end user may access communications services. If the end user successfully negotiates the security procedures of the Unified Communications Module 20, the Unified Communications Module 20 also determines what communications services the end user may access and configure. When the end user receives the unified communications webpage 36 (shown as “UCW”), the unified communications webpage 36 also includes one or more embedded Uniform Resource Locator (“URL”) links 40. Each embedded URL link 40 corresponds to a web server for configuring a communications service. Even though the unified communications webpage 36 is communicated from a communications service provider (such as BellSouth Corp.), each embedded URL link 40 provides a communications link to a third-party vendor's application. If the end user wishes to configure a communications service offered by a vendor, the end user need only select the corresponding embedded URL link 40. The end user is thus permitted to configure multiple applications from third-party vendors using a single, unified web portal.

FIG. 1 illustrates some possible communications applications. If, for example, the end user wishes to configure an email service, the end user can select an embedded Uniform Resource Locator (“URL”) link 40 corresponding to an email web server 42. The embedded URL link 40 is a Uniform Resource Locator (URL) corresponding to the email web server 42. The end user computer 28 is then redirected to a web page downloaded from the email web server 42 via the secure network 34 and via the distributed computing network 38. The email web server 42 thus provides a webpage interface to an email application server 44. After the end user has completed configuring their email service, the webpage interface to the email application server 44 would include a URL link that returns the end user to the unified communications webpage 36.

The end user may also configure a unified messaging service. If the end user has authorization/privileges to configure a unified messaging service, the unified communications webpage 36 may also include an embedded Uniform Resource Locator link to a unified messaging web server 46. The unified messaging web server 46 provides a webpage interface to a unified messaging application server 48. If the end user has administrative privileges, the end user may view, add, delete, and make changes to end user mailboxes. If the end user is a subscriber, having lesser privileges, the subscriber may only have authority to make changes to their individual account. After the end user has completed configuring their unified messaging service, the webpage interface to the unified messaging application server 48 would include a URL link to the unified communications webpage 36.

The end user may also configure a conferencing service. If the end user has authorization/privileges to configure a conferencing service, the unified communications webpage 36 may also include an embedded Uniform Resource Locator link to a conferencing web server 50. The conferencing web server 50 provides a webpage interface to a conferencing application server 52. The conferencing web server 50 allows the user to establish a conferencing session and/or attend a conferencing session by entering a conference ID and a passcode. The conferencing web server 50 allows the user to set-up a conference bridge with a date, time, and the number of desired ports/participants. After the end user has completed configuring their conferencing session, the webpage interface to the conferencing application server 52 would include a URL link to the unified communications webpage 36.

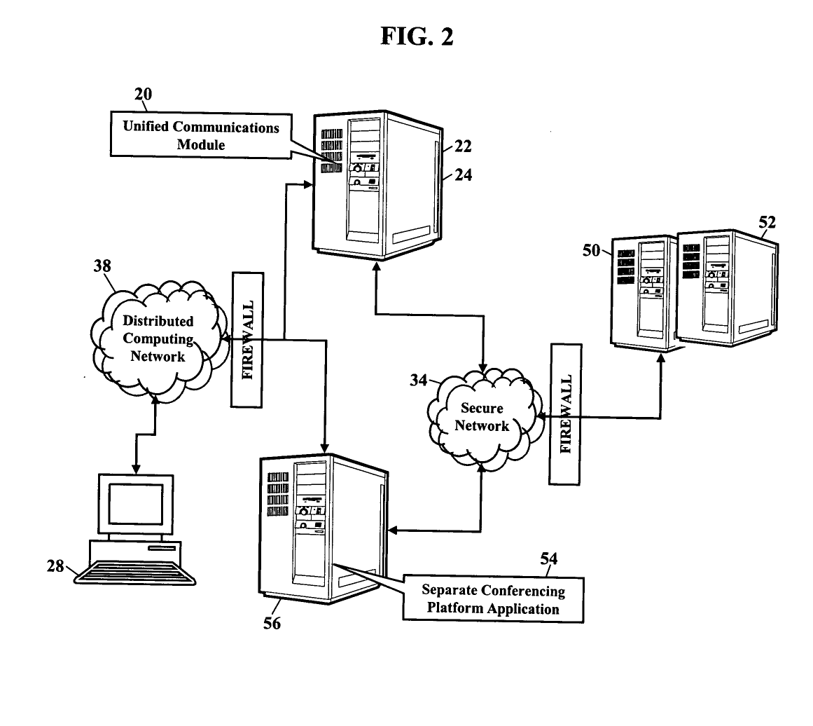

FIG. 2 is a schematic illustrating an alternative architecture for a conferencing service. Because the conferencing service could have both subscribing participants and non-subscribing, outside guests, the conferencing service may include a separate conferencing platform application 54. The separate conferencing platform application 54 operates within a separate, public conferencing computer server 56. The separate conferencing platform application 54 provides enhanced security for/from non-subscribing, public guests. If the end user is authenticated as a valid subscriber, the end user accesses the conferencing web server 50 via the secure web server 24. If, however, the end user is a non-subscriber guest, the guest accesses the conferencing web server 50 via the separate conferencing platform application 54 operating within the separate conferencing computer server 56. This conferencing service allows a subscriber to establish a conference session, yet the conferencing service only allows a non-subscriber to participate in a conferencing session. This separate conferencing path for non-subscriber guests helps shield the Unified Communications Module 20, and the web server 24, from viruses, hackers, and intrusions. This separate conferencing path thus reduces security concerns from public participants to conference sessions.

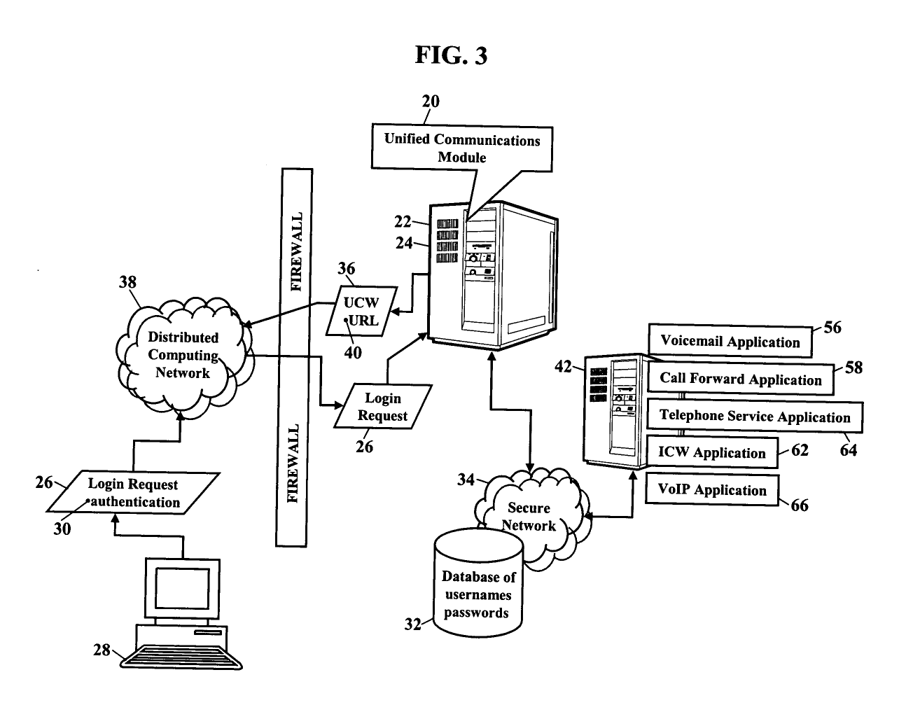

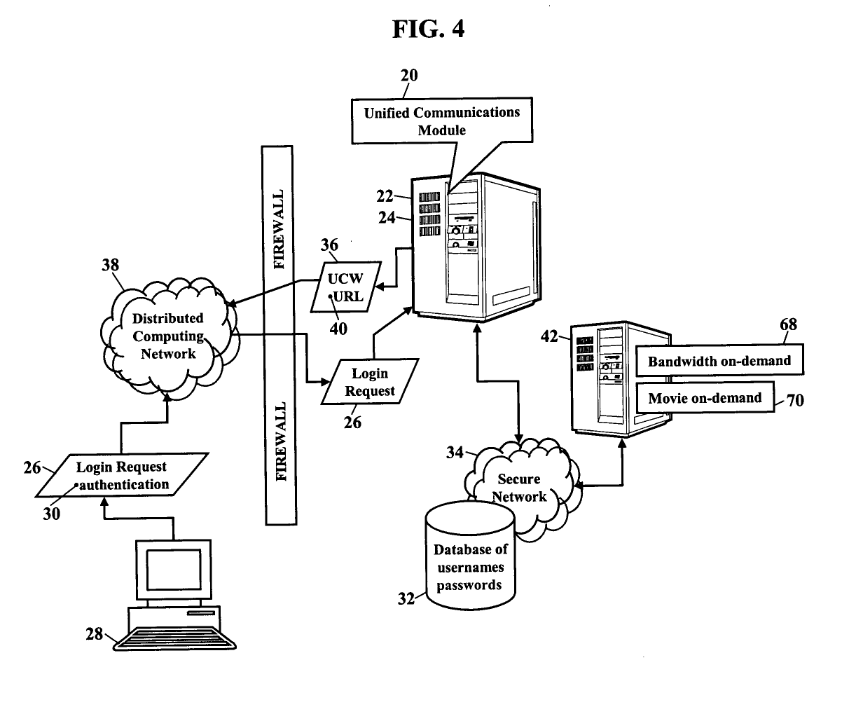

FIGS. 3 and 4 are schematics illustrating additional communications services. The Unified Communications Module 20, as earlier mentioned, provides a single, unified web portal for configuring multiple communications applications. These multiple communications services may be provided by a service provider and/or by a third-party vendor. If the end user successfully negotiates the security procedures of the Unified Communications Module 20, the Unified Communications Module 20 determines what communications services the end user may access and configure. If the database 32 of valid usemarnes and passwords authenticates the end user, the database 32 of valid usernames and passwords also stores access privileges for the end user. The unified communications webpage 36 (shown as “UCW”) then includes the one or more embedded Uniform Resource Locator (“URL”) links 40 that correspond to each accessible web server. FIG. 3 illustrates various other communications applications to which the end user may access and configure. The end user, for example, may have privileges to access and to configure a voicemail application 56, a call forwarding application 58, a telephone service application 60, an Internet Call Waiting (“ICW”) application 62, and/or a Voice Over Internet Protocol (“VoIP”) application 64.

FIG. 4 shows additional communications services. The end user may have privileges to access and to configure a bandwidth on-demand communications service 68 and/or a movie on-demand service 70. The bandwidth on-demand communications service 68 allows the user to dynamically receive increased bandwidth for downloading data. This bandwidth on-demand communications service 68, however, would then terminate once the data is downloaded. That is, once the data is successfully communicated to the end user computer 28, the increased bandwidth is eliminated. The end user's communications configuration returns to a “normal” bandwidth. The bandwidth on-demand communications service 68 may also allow the user to receive increased bandwidth for uploading data and, when the data is uploaded, the increased bandwidth is then eliminated. The end user may additionally or alternatively receive increased bandwidth for a limited time, such as minutes, hours, days, or other interval. The bandwidth on-demand communications service 68 could resemble a “buffet” of bandwidth, in which the end user uploads/downloads data within the allotted interval of time. The bandwidth on-demand communications service 68 could provide a network-initiated return to a slower rate after completion of download—that is, Unified Communications Module 20 (or some other intelligently-controlled device in the network) detects that the increased bandwidth is no longer needed. The network itself, then, would eliminate the increased bandwidth. The Unified Communications Module 20 (or other intelligently-controlled network device) could also monitor bandwidth usage. If the increased bandwidth is not being utilized, the network itself could eliminate the increased bandwidth. If, for example, the increased bandwidth is provided, but the increased bandwidth is not required and/or not used for a predetermined time (e.g., 5 minutes), the Unified Communications Module 20 and/or the network could unilaterally eliminate the increased bandwidth. The user/subscriber, too, could have authority to define how the increased bandwidth is provided. The content itself could also define the increased bandwidth. The content, for example, could include triggers, tags, metadata, or other coding to indicate when the increased bandwidth should be provided, and when the increased bandwidth should be eliminated. A bandwidth-intensive movie, for example, could include coding at the beginning of the data stream and at the end of the data stream. The coding at the beginning of the data stream would initiate the increased bandwidth, and the coding at the end of the data stream would eliminate the increased bandwidth.

The end user may also have privileges to access and to configure the movie on-demand service 70. This movie on-demand service 70 allows the end user to download a movie/video to the end user computer 28. If the end user requires increased bandwidth to download the movie, the movie on-demand service 70 may also include increased bandwidth for downloading the movie. When the movie is successfully downloaded, the increased bandwidth is then eliminated. This concept of increased bandwidth could be applied to any file transaction, such as uploading/downloading audio files, text files, Hyper Text Markup Language (HTML) files, picture files, and any other content.

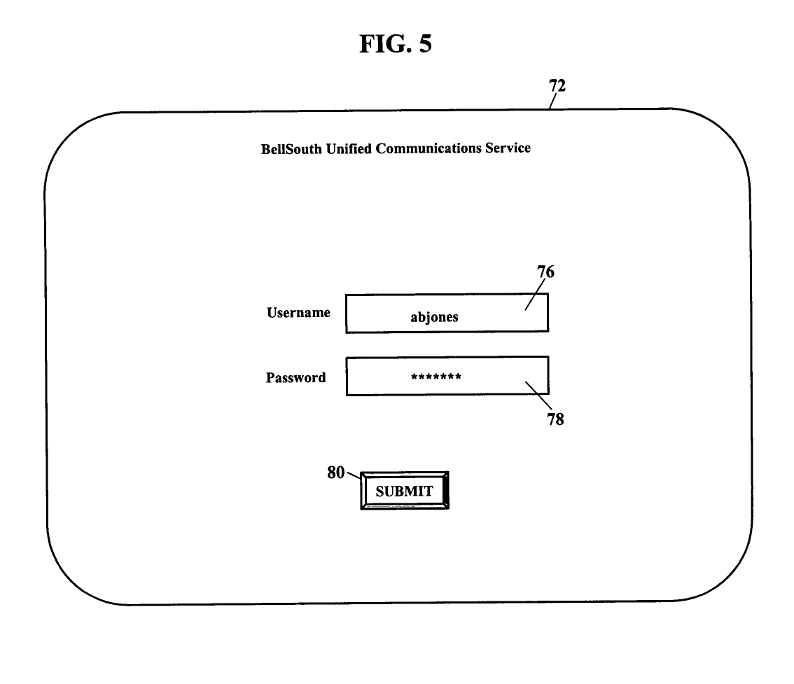

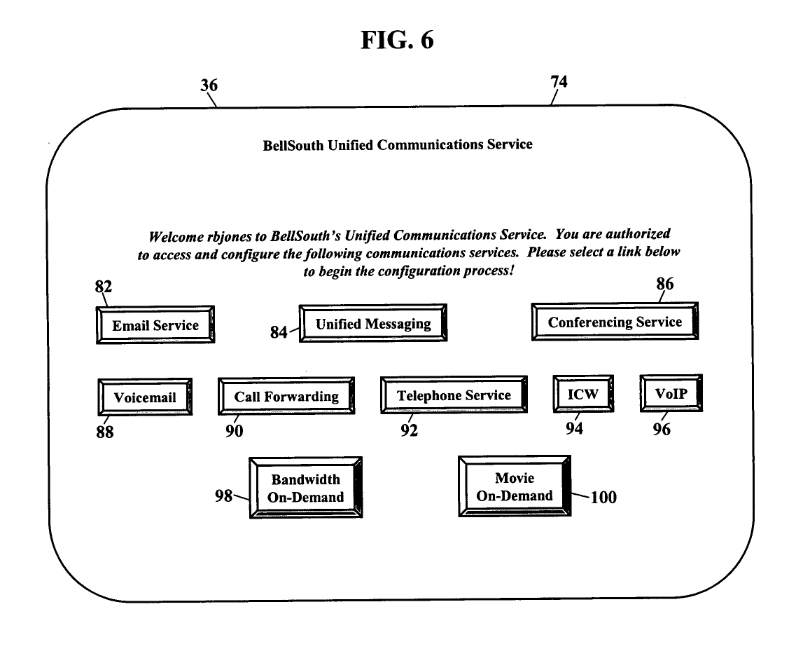

FIGS. 5 and 6 are schematics illustrating Graphical User Interfaces, according to more embodiments of this invention. FIG. 5 shows a login Graphical User Interface 72, while FIG. 6 shows one possible representation of a unified communications Graphical User Interface 74. The login Graphical User Interface 72 provides a “single sign-on” feature. The end user enters a username 76 and a password 78 and selects a “Submit” button 80. The login Graphical User Interface 72 is thus a graphical representation of the login request from an end user computer (shown, respectively, as reference numerals 26 and 28 in FIGS. 1-4). The Unified Communications Module (shown as reference numeral 20 in FIGS. 1-4) authenticates the username 76 and the password 78. If the end user is authenticated/validated, As FIG. 5 shows, the Unified Communications Module return communicates the unified communications webpage.

FIG. 6 shows the unified communications Graphical User Interface 74. The unified communications Graphical User Interface 74 represents one possible visual embodiment of the unified communications webpage 36. When the end user is authenticated, the unified communications webpage 36 presents the Uniform Resource Locator (“URL”) links 40 for which the end user has configuration privileges. As FIG. 6 shows, the end user may be presented with an email URL link 82 to the email web server (shown as reference numeral 42 in FIG. 1). The end user may also be presented with a unified messaging URL link 84 to the unified messaging web server (shown as reference numeral 46 in FIG. 1) and with a conferencing URL link 86 to the conferencing web server (shown as reference numeral 50 in FIG. 1). The end user may also receive a voicemail URL link 88 to the voicemail application (shown as reference numeral 56 in FIG. 3), a call forwarding URL link 90 to the call forwarding application (shown as reference numeral 58 in FIG. 3), a telephone service URL link 92 to the telephone service application (shown as reference numeral 64 in FIG. 3), an Internet Call-Waiting (“ICW”) URL link 94 to the ICW application (shown as reference numeral 62 in FIG. 3), and a Voice Over Internet Protocol (“VoIP”) URL link 96 to the VoIP application (shown as reference numeral 66 in FIG. 3). The end user may also receive a bandwidth URL link 98 to the bandwidth on-demand application (shown as reference numeral 68 in FIG. 4) and a movie URL link 100 to the movie on-demand service (shown as reference numeral 70 in FIG. 4). The user selects the URL link for which configuration is desired, and the Unified Communications Module (shown as reference numeral 20 in FIGS. 1-4) authorizes a communications link to the appropriate application server.

This invention provides a secure “front-end web server.” The end user, in the past, had to separately login to each communications application, configure the application, and then logout of the application. Heretofore if the end user wanted to configure multiple applications, the end user had to separately login and logout for each application. This invention, however, provides a common “front end” for these separate communications applications. Because this invention utilizes a single sign-on feature, the end user can quickly and easily access and configure a group of applications/features. No separate login/logout process is necessary. Once the user is authenticated by the web server (shown as reference numeral 24 in FIGS. 1-4), the authentication results are passed/communicated to authorized servers. The end user login occurs at the web server, and the successful authentication is passed to the communications applications. The centralized database of login usernames and passwords also streamlines administration of user accounts.

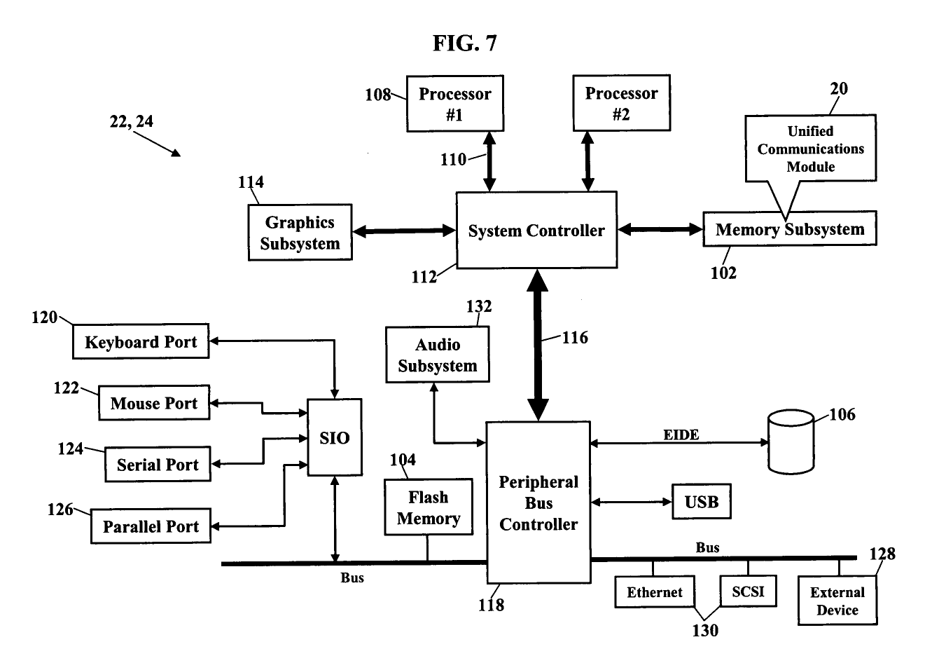

FIG. 7 illustrates an alternative operating environment for this invention. FIG. 7 is a block diagram showing the Unified Communications Module 20 residing in the computer system 22. The computer system 22 may be any computing system, such as the web server 24. As FIG. 7 shows, the Unified Communications Module 20 operates within a system memory device. The Unified Communications Module 20, for example, is shown residing in a memory subsystem 102. The Unified Communications Module 20, however, could also reside in flash memory 104 or a peripheral storage device 106. The computer system 22 also has one or more central processors 108 executing an operating system. The operating system, as is well known, has a set of instructions that control the internal functions of the computer system 22. A system bus 110 communicates signals, such as data signals, control signals, and address signals, between the central processor 108 and a system controller 112 (typically called a “Northbridge”). The system controller 112 provides a bridging function between the one or more central processors 108, a graphics subsystem 114, the memory subsystem 102, and a PCI (Peripheral Controller Interface) bus 116. The PCI bus 116 is controlled by a Peripheral Bus Controller 118. The Peripheral Bus Controller 118 (typically called a “Southbridge”) is an integrated circuit that serves as an input/output hub for various peripheral ports. These peripheral ports are shown including a keyboard port 120, a mouse port 122, a serial port 124 and/or a parallel port 126 for a video display unit, one or more external device ports 128, and networking ports 130 (such as SCSI or Ethernet). The Peripheral Bus Controller 118 also includes an audio subsystem 132. Those of ordinary skill in the art understand that the program, processes, methods, and systems described in this patent are not limited to any particular computer system or computer hardware. Other architectures are possible, and the Unified Communications Module 20 can operate in any architecture.

Those of ordinary skill in the art also understand the central processor 108 is typically a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), Sun Microsystems, Inc. (4150 Network Circle, Santa Clara Calif. 95054, www.sun.com), and Transmeta Corp. (3940 Freedom Circle, Santa Clara, Calif. 95054, www.transmeta.com). Those skilled in the art further understand that the program, processes, methods, and systems described in this patent are not limited to any particular manufacturer's central processor.

The preferred operating system is the UNIX® operating system (UNIX® is a registered trademark of the Open Source Group, www.opensource.org). Other UNIX-based operating systems, however, are also suitable, such as LINUX® or a RED HAT® LINUX-based system (LINUX® is a registered trademark of Linus Torvalds, and RED HAT® is a registered trademark of Red Hat, Inc., Research Triangle Park, N.C., 1-888-733-4281, www.redhat.com). Other operating systems, however, are also suitable. Such other operating systems would include a WINDOWS-based operating system (WINDOWS® is a registered trademark of Microsoft Corporation, One Microsoft Way, Redmond Wash. 98052-6399, 425.882.8080, www.Microsoft.com). and Mac® OS (Mac® is a registered trademark of Apple Computer, Inc., 1 Infinite Loop, Cupertino, Calif. 95014, 408.996.1010, www.apple.com). Those of ordinary skill in the art again understand that the program, processes, methods, and systems described in this patent are not limited to any particular operating system.

The system memory device (shown as memory subsystem 102, flash memory 104, or peripheral storage device 106) may also contain an application program. The application program cooperates with the operating system and with a video display unit (via the serial port 124 and/or the parallel port 126) to provide a Graphical User Interface (GUI). The Graphical User Interface typically includes a combination of signals communicated along the keyboard port 120 and the mouse port 122. The Graphical User Interface provides a convenient visual and/or audible interface with a user of the computer system 22.

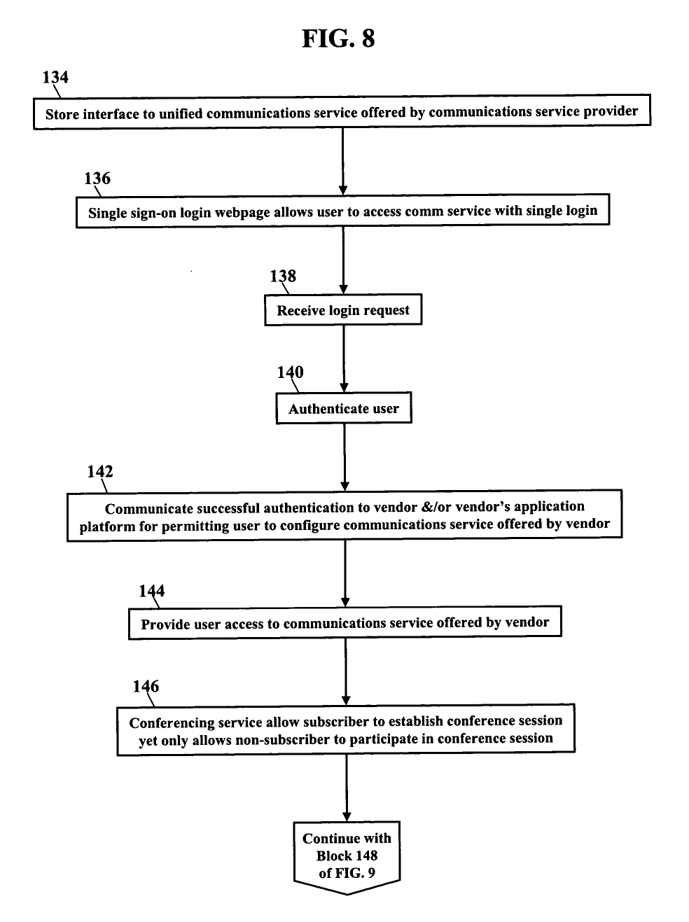

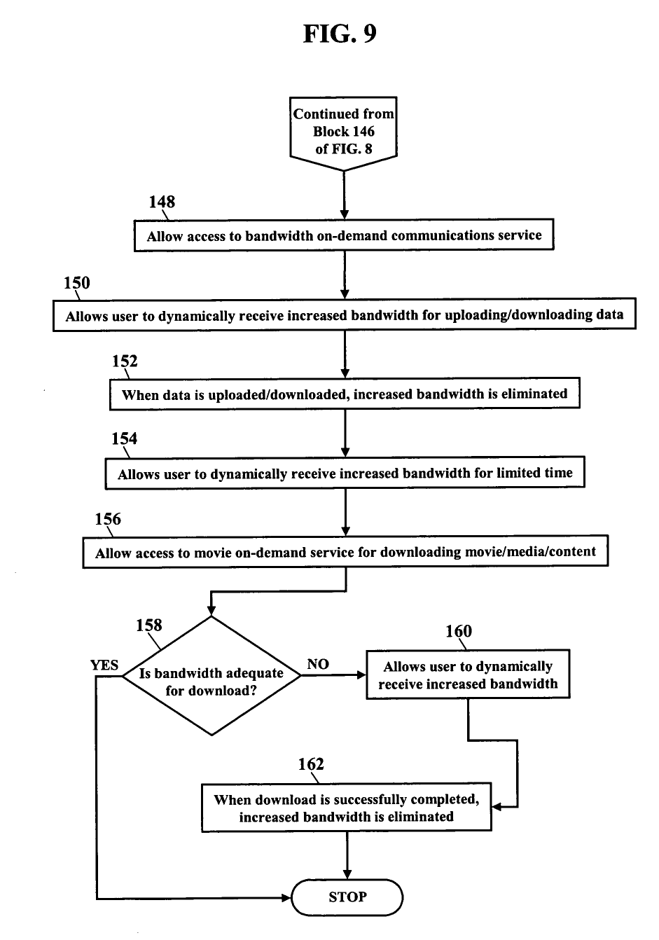

FIGS. 8 and 9 are flowcharts illustrating a method for providing unified access to communications services. An interface to a unified communications service, offered by a communications service provider, is stored in memory (Block 134). The interface may include a single sign-on login webpage (Block 136) allowing a user to access a communications service with a single login. A login request is received (Block 138) and a user is authenticated (Block 140). The user's authentication is communicated to the vendor and/or the vendor's application platform (Block 142), and the authentication permits the user to configure the communications service offered by the vendor. If the user is authenticated, then the user is provided access to the communications service offered by a vendor (Block 144). The user may access a conferencing service (Block 146). The conferencing service allows a subscriber to establish a conference session, yet the conferencing service only allows a non-subscriber to participate in the conferencing session.

The flowchart continues with FIG. 9. The user may access a bandwidth on-demand communications service (Block 148). The bandwidth on-demand communications service allows the user to dynamically receive increased bandwidth for uploading/downloading data (Block 150). When the data is uploaded/downloaded, the increased bandwidth is eliminated (Block 152). The bandwidth on-demand communications service may also allow the user to dynamically receive increased bandwidth for a limited time (Block 154). The user may also access a movie on-demand service for downloading a movie and/or other content or media (Block 156). If the user's existing bandwidth is inadequate (Block 158), the user dynamically receives increased bandwidth to adequately complete the download (Block 160). When the download is successfully completed, the increased bandwidth is eliminated (Block 162).

The Unified Communications Module may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the present invention, allow the Unified Communications Module to be easily disseminated. A computer program product for verifying the Unified Communications of web server content includes the Unified Communications Module stored on the computer-readable medium. The Unified Communications Module receives results from a client-resident Unified Communications program operating on a client computer. The client-resident Unified Communications program verifies the Unified Communications of a web resource communicated from a web server to the client computer. The Unified Communications Module also receives results from a server-resident Unified Communications program operating on the web server. The Unified Communications Module merges the results of the client-resident Unified Communications program and the server-resident Unified Communications program and presents the merged results at a computer system.

The Unified Communications Module may also be physically embodied on or in any addressable (e.g., HTTP, I.E.E.E. 802.11, Wireless Application Protocol (WAP)) wireline or wireless device capable of presenting an IP address. Examples could include a computer, a wireless personal digital assistant (PDA), an Internet Protocol mobile phone, or a wireless pager.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

1. A method, comprising the steps of:
storing an interface to a unified communications service offered by a communications service provider;
authenticating a user to the unified communications service; and
if the user is authenticated, then providing the user with access to one or more communications services offered by a vendor.

2. A method according to claim 1, wherein the step of storing the interface comprises storing a single sign-on login webpage, the single sign-on login webpage allowing the user to access the one or more communications services with a single login.

3. A method according to claim 1, wherein if the user is authenticated, then communicating that authentication to the vendor's application platform providing the one or more communications services.

4. A method according to claim 1, wherein if the user is authenticated, then communicating that authentication to the vendor providing the one or more communications services, the authentication permitting the user to configure the one or more communications services offered by the vendor.

5. A method according to claim 1, wherein the step of providing the user with access to the one or more communications services comprises providing access to a conferencing service, the conferencing service allowing a subscriber to establish a conference session, yet the conferencing service only allowing a non-subscriber to participate in the conferencing session.

6. A method according to claim 1, wherein the step of providing the user with access to the one or more communications services comprises providing access to a bandwidth on-demand communications service, wherein the user may dynamically receive increased bandwidth for a limited time.

7. A method according to claim 1, wherein the step of providing the user with access to the one or more communications services comprises providing access to a bandwidth on-demand communications service, wherein the user may receive increased bandwidth for downloading data and, when the data is downloaded, the increased bandwidth is eliminated.

8. A method according to claim 1, wherein the step of providing the user with access to the one or more communications services comprises providing access to a bandwidth on-demand communications service, wherein the user may receive increased bandwidth for uploading data and, when the data is uploaded, the increased bandwidth is eliminated.

9. A method according to claim 1, wherein the step of providing the user with access to the one or more communications services comprises providing access to a movie on-demand communications service, wherein the user may receive increased bandwidth for downloading a movie and, when the movie is downloaded, the increased bandwidth is eliminated.

10. A method according to claim 1, wherein the step of providing the user with access to the one or more communications services comprises providing access to a movie on-demand communications service, wherein the user may download a movie.

11. A method, comprising the steps of:
storing an interface to a unified communications service offered by a communications service provider;
authenticating a user to the unified communications service; and
if the user is authenticated, then providing the user with access to a bandwidth on-demand communications service, the bandwidth on-demand communications service allowing the subscriber to receive increased bandwidth for downloading data and, when the data is downloaded, the increased bandwidth is eliminated.

12. A method according to claim 11, wherein the bandwidth on-demand communications service allows the subscriber to dynamically receive the increased bandwidth for a limited time.

13. A method according to claim 11, wherein the bandwidth on-demand communications service allows the subscriber to receive increased bandwidth for uploading data and, when the data is uploaded, the increased bandwidth is eliminated.

14. A method according to claim 11, wherein the bandwidth on-demand communications service provides a network-initiated elimination of the increased bandwidth.

15. A method according to claim 11, wherein the bandwidth on-demand communications service eliminates the increased bandwidth when idle for a predetermined time.

16. A method according to claim 11, wherein the bandwidth on-demand communications service is defined by coding in the data, the coding in the data indicating when the increased bandwidth should be received.

17. A method according to claim 11, wherein the bandwidth on-demand communications service is defined by coding in the data, the coding in the data indicating when the increased bandwidth should be eliminated.

18. A system, comprising:
a Unified Communications Module stored in a memory device, and a processor communicating with the memory device;
the Unified Communications Module storing an interface to a unified communications service offered by a communications service provider, the Unified Communications Module authenticating the user to the unified communications service, and if the user is authenticated, then providing the user with access to a bandwidth on-demand communications service, the bandwidth on-demand communications service allowing the subscriber to receive increased bandwidth for downloading data and, when the data is downloaded, the increased bandwidth is eliminated.

19. A system according to claim 18, wherein the Unified Communications Module allows the user to access a movie on-demand communications service, wherein the user may receive increased bandwidth for downloading a movie and, when the movie is downloaded, the increased bandwidth is eliminated.

20. A system according to claim 18, wherein the Unified Communications Module allows the user to access a movie on-demand communications service, wherein the user may download a movie.
